(19) United States
(12) Patent Application Publication
(10) Pub. No.: US 2013/0151345 A1
(43) Pub. Date: Jun. 13, 2013

(54) SOCIAL REPUTATION ADS

(71) Applicant: Jonathan Brelig, San Francisco, CA (US)

(72) Inventor: Jonathan Brelig, San Francisco, CA (US)

(73) Assignee: YAHOO! INC., Sunnyvale, CA (US)

(21) Appl. No.: 13/315,026

(22) Filed: Dec. 8, 2011

(51) Int. Cl. G06Q 30/02

(52) U.S. Cl. 705/14.66

(57) ABSTRACT

In one embodiment, a social authority score associated with a user is determined, where the social authority score indicates a level of social influence of the user. One of a plurality of advertisements is identified based, at least in part, upon the social authority score associated with the user. The one of the plurality of advertisements is then provided to the user.

### BACKGROUND OF THE INVENTION

The disclosed embodiments relate generally to methods and apparatus for advertising to users based, at least in part, upon the users' social authority.

Advertisers typically pay online publishers to place their ads on a web page. In a popular pricing model, an advertiser is charged based upon the number of impressions that are delivered. Other pricing models may also be used. For example, in the pay-per-click mode, each advertiser is typically charged only when her ad receives a click.

Advertisers generally request that a minimum number of impressions (i.e., views) be guaranteed. In addition, advertisers may also specify additional conditions that are to be satisfied by the online publisher of the ads. For example, the advertisers may specify a desired target profile of users who are to receive a particular advertisement. As another example, advertisers may also specify a particular position in which an advertisement is to be placed on a web page. A publisher will therefore typically attempt to maximize their profits (e.g., by achieving high click-through-rates), while satisfying the requirements of the advertisers. Unfortunately, selecting advertisements to be provided to users while satisfying the requirements of advertisers is a complex process.

### SUMMARY OF THE INVENTION

The disclosed embodiments enable advertising to be performed based, at least in part, upon social authority. The social authority of a user may indicate a level of social influence of the user. More particularly, the level of social influence may be based upon factors such as number of followers of the user, the number of contacts of the user, and/or title of the user.

In one embodiment, a social authority score associated with a user may be determined, where the social authority score indicates a level of social influence of the user. One of a plurality of advertisements may be identified based, at least in part, upon the social authority score associated with the user. The advertisement may then be provided to the user.

In another embodiment, one of a plurality of advertisements may be identified based, at least in part, upon a profile of a user. The one of the plurality of advertisements may be provided to the user. A social authority score associated with the user may be determined, where the social authority score indicates a level of social influence of the user. A charge for providing the identified one of the plurality of advertisements to the user may be ascertained based, at least in part, upon the social authority score associated with the user.

In another embodiment, the invention pertains to a device comprising a processor, memory, and a display. The processor and memory are configured to perform one or more of the above described method operations. In another embodiment, the invention pertains to a computer readable storage medium having computer program instructions stored thereon that are arranged to perform one or more of the above described method operations.

These and other features and advantages of the present invention will be presented in more detail in the following specification of the invention and the accompanying figures which illustrate by way of example the principles of the invention.

### BRIEF DESCRIPTION OF THE DRAWINGS

FIG. 1 is a diagram illustrating an example system in which embodiments of the invention may be implemented.

FIG. 2 is a process flow diagram illustrating an example method of serving advertisements to users in accordance with various embodiments.

FIG. 3 is a process flow diagram illustrating an example method of charging advertisers for advertisements that are served to users in accordance with various embodiments.

FIG. 4 is a simplified diagram of an example network environment in which various embodiments may be implemented.

FIG. 5 illustrates an example computer system in which various embodiments may be implemented.

### DETAILED DESCRIPTION OF THE SPECIFIC EMBODIMENTS

Reference will now be made in detail to specific embodiments of the invention. Examples of these embodiments are illustrated in the accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

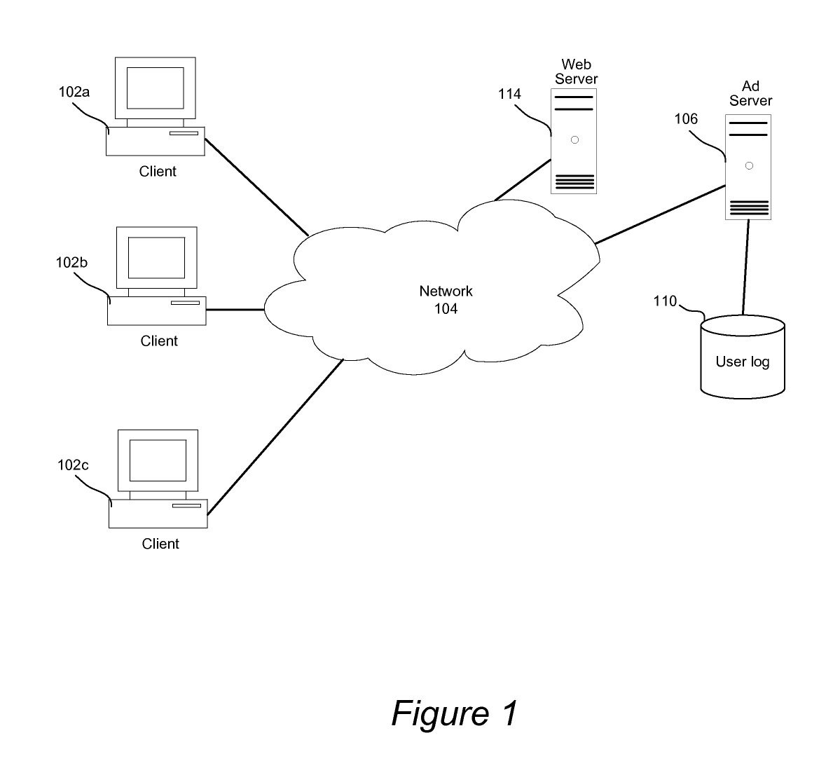

FIG. 1 illustrates an example network segment in which various embodiments of the invention may be implemented. As shown, a plurality of clients 102a, 102b, 102c may each receive an impression (i.e., view) of one or more advertisements upon accessing a web page via a web server 114, as will be described in further detail below. Alternatively, an advertisement may be transmitted to the clients 102a, 102b, 102c by the ad server(s) 106 via electronic mail, text message, or digital television. Advertisements may be transmitted via an ad server 106, which may be coupled to the web server 114, as shown. However, it is important to note that the disclosed embodiments may be implemented via any number of servers.

The clients 102a, 102b, 102c may be coupled to the web server 114 via a network 104. The network 104 may take any suitable form, such as a wide area network or Internet and/or one or more local area networks (LAN's). The network 104 may include any suitable number and type of devices, e.g., routers and switches, for forwarding data and/or search or web object requests from each client to the search or web application and search or web results back to the requesting clients.

The web server 114 may provide services associated with a social network. Example social networks include, but are not limited to, Yahoo, Facebook, Twitter, and Linked In. The services provided by the social network may include matchmaking services, social or business networking services, messaging services, and/or the ability to share content such as photos or videos.

The ad server 106 (or servers) of the online publisher may have access to one or more user logs 110 (e.g., user databases) into which user information is retained. This user information or a portion thereof may be referred to as a user profile. More particularly, the user profile may include public information that is available in a public profile and/or private information. The user logs 110 may be retained in one or more memories that are coupled to the ad server 106.

The user information retained in the user logs 110 may include personal information such as demographic information (e.g., age and/or gender) and/or geographic information (e.g., residence address, work address, and/or zip code). In addition, each time a user performs online activities such as clicking on an advertisement or purchasing goods or services, information regarding such activity or activities may be retained as user data in the user logs 110. For instance, the user data that is retained in the user logs 110 may indicate the identity of web sites visited, identity of ads that have been selected (e.g., clicked on) and/or a timestamp. Moreover, where the online publisher supports a search engine (e.g., via the ad server 106 or a separate search server), information associated with a search query, such as search term(s) of the search query, information indicating characteristics of search results that have been selected (e.g., clicked on) by the user, and/or associated timestamp may also be retained in the user logs 110. A user may be identified in the user logs 110 by a user ID (e.g., user account ID), information in a user cookie, etc.

In accordance with various embodiments, the user logs 110 may maintain a social authority score and/or social authority data for each user. A social authority score of a user may indicate a level of social influence of the user. The social authority data may include one or more indicators from which a social authority score may be calculated. For example, the social authority data may indicate a number of followers of the user, a number of accounts that the user is following, list memberships, a number of contacts of the user, number or frequency of posts by the user, type of content posted by the user, number or frequency of “reposts” or “retweets” of content posted by the user (e.g., by followers or contacts of the user), the likelihood that the user's post will generate actions (e.g., clicks, retweets or reposts, messages, likes and/or comments), the number of times the user is mentioned (e.g. in posts), how influential the user's followers and/or contacts are (e.g., the social authority scores of the followers and/or contacts), how influential the user's followers and/or contacts are that repost or retweet content posted by the user, and/or a title of the user. The term “follower” generally refers to a user who has subscribed to receive updates of another user.

The content posted by the user may include a message, text, audio, image (e.g., photo or generated image), video content, and/or check-ins. A check-in may include a date and/or time, as well as a geographical coordinate and/or point of interest (POI). The user may post content by posting a file including the content. Alternatively, the user may post content by posting a Uniform Resource Locator (URL) or link to the content.

In accordance with various embodiments, the ad server(s) 106 may obtain a social authority score(s) for one or more users. The social authority score(s) may be obtained via an Application Programming Interface (API) from a web site such as Klout.com and stored in the user logs 110. Alternatively, the server(s) 106 may collect social authority data for one or more users, which may be stored in the user logs 110 and/or used to calculate the social authority score(s) for the users. Social authority score(s) that are calculated by the system may be stored in the system logs 110.

The social authority score of a user may represent how successful the user is at engaging their audience and how big of an impact their messages or posts have on people. More particularly, the social authority score may indicate the size of the user's engaged audience (e.g., based upon the number and actions of the user's followers and contacts who actively listen or react to posts of the user). The social authority score may also indicate the likelihood that the user's posts will generate actions and/or how influential the user's engaged audience is. In this manner, the social authority score may measure a user's online influence.

Embodiments disclosed herein for selecting an advertisement to deliver to a user based, at least in part, upon the user's social authority score may be implemented via the ad server 106. Furthermore, embodiments for charging advertisers based, at least in part, upon the social authority scores of users receiving the advertisements may also be implemented via the ad server 106. The disclosed embodiments may be implemented via software and/or hardware.

An online publisher (i.e., web publisher) will generally be responsible for delivering multiple advertisements via the Internet (or other communication media such as email, text message, or digital television). A contract agreement associated with a particular advertisement may specify a minimum number of page views (i.e., impressions) to be delivered within a particular period of time. The web publisher is therefore responsible for providing the requested number of impressions for each advertisement.

An advertisement may include content pertaining to a product or service, which may be delivered via the Internet, email, text message, or digital television. The content typically includes text. However, it is important to note that an advertisement may include text, one or more images, video, and/or audio. An advertisement may also include one or more hypertext links, enabling a user to proceed with the purchase of a particular product or service.

The disclosed embodiments support the dynamic selection and transmission of advertisements to users. Advertisements may be provided to users via a variety of communication media including, but not limited to, a web site (e.g., via display on a web page of the web site), electronic mail, Short Message Service (SMS), a mobile device (e.g., text message), or another medium such as digital television, which may be connected to the Internet. For instance, selected advertisement(s) may be provided to a user via the Internet. Specifically, when a user visits a web page via the Internet, the system (e.g., ad server 106) may automatically select an advertisement to be served to the user (e.g., by placing the advertisement in the web page). The publisher may then automatically provide the selected advertisement(s) to the user.

When an advertisement is provided to a particular user, information pertaining to the advertisement (e.g., identifying a product or service advertised in the advertisement) may be stored in association with the user's account data. In addition, the server(s) 106 may automatically collect online (and/or real world) behavioral data for any of users 102a, 102b, 102c to determine whether the advertisement was successful. In other words, the server(s) 106 may determine whether the user purchased the product or service advertised in the advertisement. Data indicating whether the advertisement was successful may also be stored in association with the user's account data and/or the advertisement.

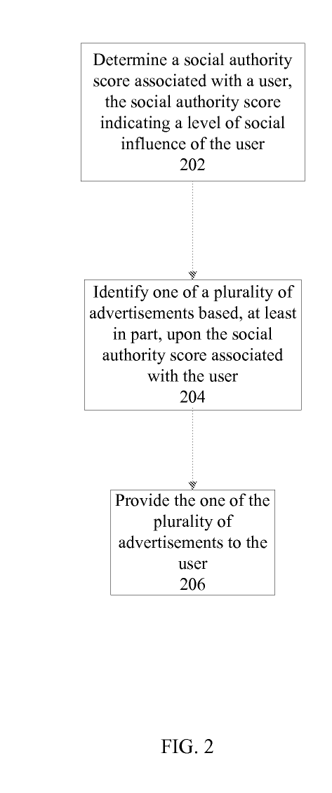

FIG. 2 is a process flow diagram illustrating an example method of serving advertisements to users in accordance with various embodiments. The system may determine a social authority score associated with a user at 202, where the social authority score indicates a level of social influence of the user. For example, when a user visits a web page via the Internet, the system may obtain the social authority score from a data source such as the system user logs.

One of a plurality of advertisements may be identified based, at least in part, upon the social authority score associated with the user at 204. More particularly, the plurality of advertisements may include any number of advertisements supplied by various advertisers. The system may apply various algorithms to identify a suitable advertisement from the plurality of advertisements based upon the social authority score, as well as other information associated with the user. For example, the user's profile (e.g., prior purchase history, general interests, and/or demographic information (e.g., age, sex, zip code)) may be used in addition to the social authority score to select one of the plurality of advertisements.

In accordance with various embodiments, a plurality of advertisements may be identified, where each of the plurality of advertisements is associated with a corresponding bid indicating a number of impressions that are to be satisfied by a target population having a set of characteristics including a social authority score within a specified range of social authority scores. One of the plurality of advertisements may then be selected. Therefore, the social authority score associated with the user may be within the specified range of social authority scores for the selected advertisement.

The selected one of the plurality of advertisements may then be provided to the user at 206. The advertiser may be charged based, at least in part, upon a range of social authority scores that has been specified by the advertiser in the bid submitted in association with the advertisement. Moreover, the advertiser may be charged with finer granularity based, at least in part, upon the social authority score of the user who has received the advertisement. An advertiser may then be billed the charge for the advertisement that has been provided. In this manner, an advertiser may be billed a higher amount for advertisements provided to users having a higher social authority score than for advertisements provided to users having a lower social authority score.

In accordance with various embodiments, the system may apply an algorithm to calculate the charge based upon the characteristics of the user receiving the advertisement. For example, the system may calculate the charge based, at least in part, upon the specific social authority score of the user. As another example, the system may maintain two or more ranges of social authority scores, where each range is associated with a particular amount or multiplying factor. The system may therefore ascertain a charge that corresponds with the range of social authority scores that includes the user's social authority score. This range of social authority scores may be the same as the range specified in the bid submitted in association with the advertisement or a different range. For example, the charge may be based upon a range of social authority scores that is a subset of the range specified in the advertiser's bid. Accordingly, the charge may be directly proportional to a multiplying factor representing a level of social influence of the user receiving the advertisement.

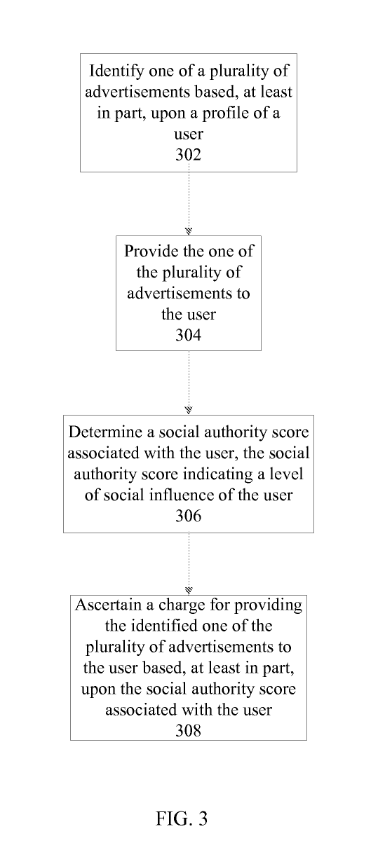

FIG. 3 is a process flow diagram illustrating an example method of charging advertisers for advertisements that are served to users in accordance with various embodiments. One of a plurality of advertisements may be identified at 302 based, at least in part, upon a profile of a user. The one of the plurality of advertisements may also be identified based, at least in part, upon the social authority score associated with the user. More particularly, each of the plurality of advertisements may be associated with a corresponding bid indicating a number of impressions that are to be satisfied with a target population having a social authority score within a specified range of social authority scores. Therefore, the social authority score of the user may be within the specified range of social authority scores for the one of the plurality of advertisements.

The one of the one of the plurality of advertisements may be provided to the user at 304. A social authority score associated with the user may be determined at 306, where the social authority score indicates a level of social influence of the user. A charge for providing the identified one of the plurality of advertisements to the user may be ascertained based, at least in part, upon the social authority score associated with the user at 308. More particularly, the charge may correspond specifically with the social authority score of the user. Alternatively, the charge may be based, at least in part, upon a range of social authority scores within which the user's social authority score falls. For example, the system may maintain two or more ranges of social authority scores, where each of the ranges of social authority scores corresponds to a particular charge or multiplying factor. Therefore, the charge may be higher for advertisements provided to users having a higher social authority score than for advertisements provided to users having a lower social authority score.

Social Authority

In accordance with various embodiments, a user's social authority score may indicate a level of social influence of the user within a particular realm. Example realms include social networks, geographic regions (e.g., neighborhoods), topics, businesses, and global. The system may obtain, calculate, and/or maintain a user's social authority score in one or more such realms. The user's social authority score in a particular realm may be applied system-wide for all purposes. Alternatively, the system may apply the user's social authority score in a particular realm solely to advertising for products or services that are pertinent to that realm.

A user's social influence within a particular social network may be ascertained based upon a number of factors. Example factors include the number of followers of the user, the number of accounts that the user is following, list memberships, the number of contacts of the user, number or frequency of posts by the user, type of content posted by the user, number or frequency of “reposts” or “retweets” of content posted by the user (e.g., by followers or contacts of the user), the likelihood that the user's post will generate actions (e.g., clicks, retweets or reposts, messages, likes and/or comments), the number of times the user is mentioned (e.g. in posts), how influential the user's followers and/or contacts are, how influential the user's followers and/or contacts are that repost or retweet content posted by the user, and/or title of the user. In this manner, the system may determine a user's social authority score indicating a level of the user's social influence within the social network.

It may also be desirable to determine a user's social influence within a particular geographic region (e.g., neighborhood). A user's social authority score may be based upon factors including, but not limited to, the number of followers of the user within the geographic region, the number of accounts that the user is following, list memberships, number of contacts of the user within the geographic region, number or frequency of posts by the user, type of content posted by the user, number or frequency of “reposts” or “retweets” of content posted by the user (e.g., by followers or contacts of the user), the likelihood that the user's post will generate actions (e.g., clicks, retweets or reposts, messages, likes and/or comments), the number of times the user is mentioned (e.g. in posts), how influential the user's followers and/or contacts are, how influential the user's followers and/or contacts are that repost or retweet content posted by the user, and/or title of the user. The geographic region of each user may be ascertained based upon information such as the user's work or residential zip code and/or address. In this manner, the system may determine a user's location-based reputation

The system may also determine a user's social influence within the business world, or with respect to a particular type of business. For example, the system may determine for each user within a social network such as LinkedIn a social authority score within the business world. The social authority score may be determined, for example, based upon the number of contacts that the user has on LinkedIn, how influential the user's followers and/or contacts are, and/or the title of the user. As another example, the system may determine a number of contacts (or followers) within a particular type of business. More particularly, the system may determine the type of business of each user of the social network based upon information such as the name of the company that the user works for, the work title of the user, prior companies that the user worked for, and/or prior work titles of the user

A topic-based social authority of a user may also be determined. For example, the topic may include a particular sport or other interest such as travel. As another example, the topic may include a particular brand, product, type of product, business, or type of business. The system may identify based upon content of postings of the user the topics or types of topics the user typically communicates about to their contacts. Thus, the type of content posted by the user may be ascertained in order to determine a particular topic-based social authority. For example, a user's social authority in skiing may be determined by monitoring the type of content posted by the user for posts pertaining to skiing.

The system may also identify products or brands that the user clicked as “Likes” within one or more social networks. The user's topic based social authority score may further be based upon the number of the user's contacts, number of followers within the social network(s), the number of accounts that the user is following, list memberships, number or frequency of postings of the user, number or frequency of “reposts” or “retweets” of content posted by the user (e.g., by followers or contacts of the user), the likelihood that the user's post will generate actions (e.g., clicks, retweets or reposts, messages, likes and/or comments), the number of times the user is mentioned (e.g. in posts), how influential the user's followers and/or contacts are, how influential the user's followers and/or contacts are that repost or retweet content posted by the user, and/or title of the user.

A global social authority score may indicate a general social influence of the user globally. The global social authority score may be obtained via an API from a web site such as Klout.com. Alternatively, the system may calculate the global social authority score based upon social authority data that is collected by the system.

It is important to note that the types of social authority described above are merely illustrative, and other types of social authority may be implemented. Moreover, although the types of social authority are described separately, two or more types of social authority may be combined to determine a user's social authority. For example, a user's social authority in skiing among those people who also live in California may be ascertained.

Advertiser Interface

The system may provide a bidding platform enabling advertisers to submit bids in association with advertisements. More particularly, an advertiser may submit a bid specifying a number of impressions for a particular advertisement and characteristics of a user population to satisfy the number of impressions. Moreover, within a bid associated with a particular advertisement, an advertiser may specify two or more subpopulations of users, where each subpopulation has associated therewith a corresponding number of impressions and characteristics of the subpopulation to satisfy the number of impressions.

The characteristics of a user population that may be specified (e.g., selected) in association with an advertiser's bid may include any number of characteristics including demographic characteristics such as age, sex, and/or zip code. In addition, the characteristics may further indicate a range of acceptable social authority scores such that the social authority score of each of the users in the user population used to satisfy the number of impressions falls within this range. Once bids are obtained from advertisers in association with a plurality of advertisements, the system may allocate the advertisements among a plurality of users.

The price that an advertiser is charged for providing an advertisement to a user may be based upon various factors. In accordance with one embodiment, the price that the advertiser is charged may depend, at least in part, upon the value of the characteristic(s) specified in the advertiser's bid. In accordance with another embodiment, the price that an advertiser is charged may depend, at least in part, upon the value of the characteristic(s) of the user population receiving the impressions. More particularly, the price associated with a particular impression may correspond with the specific social authority score of the user or more generally to a range of social authority scores that includes the social authority score of the user. The price charged for a particular impression may be ascertained through the use of a look up table or through the use of a more complex calculation that is based, at least in part, upon the value of the social authority score(s) of the user(s) receiving the advertisement and/or on value of the social authority score(s) on which the advertiser bid. Therefore, the price that the advertiser is charged may vary according to the social authority score of the users receiving the advertisement and/or the range of social authority scores that the advertiser has specified in the advertiser's bid.

The system may provide a graphical user interface informing advertisers of standard advertising charges associated with specific characteristics including various social authority scores and/or ranges of social authority scores. For example, the bidding platform may enable advertisers to select one of a plurality of social authority score ranges in association with each subpopulation of user impressions, where each of the social authority score ranges has a price (or range of prices) associated therewith. The system may further provide a graphical user interface enabling advertisers to monitor the charges accrued in association with each advertisement.

The system may determine the effectiveness of the advertisement based upon whether the user purchased the product or service advertised to the user. For example, the system may ascertain whether the user visited a location or business that was advertised in the advertisement. This may be accomplished by ascertaining whether the user checked in to the location or business via a mobile device, or through other mechanisms. From this information, it is possible to determine whether the advertisement was effective in influencing future user behavior. This determination may be used to further tune the ability of the system to select an appropriate advertisement to provide to a user under various circumstances. Information pertaining to effectiveness of the advertisement may be provided to the advertiser via a graphical user interface.

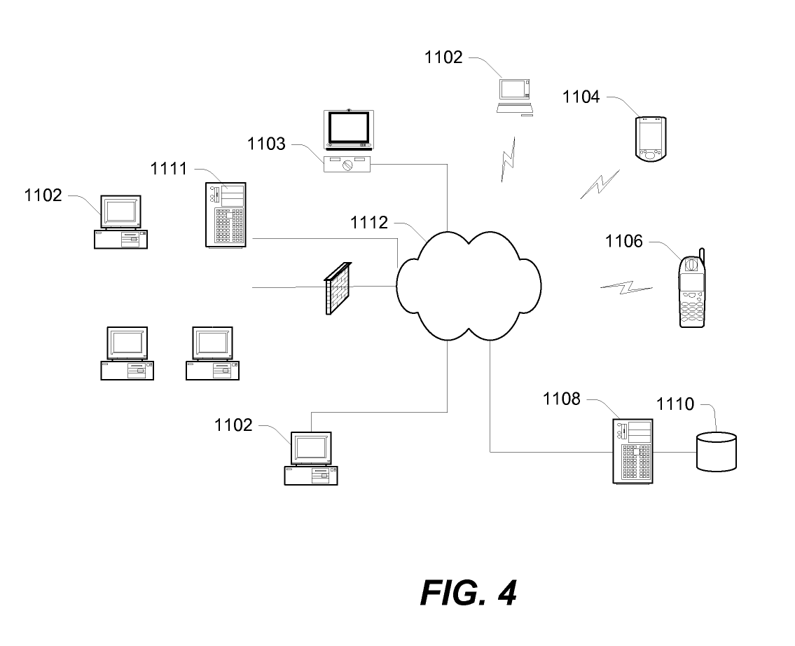

The disclosed embodiments may be implemented in any of a wide variety of computing contexts. For example, as illustrated in FIG. 4, implementations are contemplated in which users interact with a diverse network environment via any type of computer (e.g., desktop, laptop, tablet, etc.) 1102, media computing platforms 1103 (e.g., cable and satellite set top boxes and digital video recorders), handheld computing devices (e.g., PDAs) 1104, cell phones 1106, or any other type of computing or communication platform.

And according to various embodiments, input that is processed in accordance with the invention may be obtained using a wide variety of techniques. For example, input for may be obtained via a graphical user interface from a user's interaction with a local application such as a mobile application on a mobile device, web site or web-based application or service and may be accomplished using any of a variety of well-known mechanisms for obtaining information from a user. However, it should be understood that such methods of obtaining input from a user are merely examples and that input for performing social authority based advertising may be obtained in many other ways.

Social authority based advertising may be performed according to the disclosed embodiments in some centralized manner. This is represented in FIG. 4 by server 1108 and data store 1110 which, as will be understood, may correspond to multiple distributed devices and data stores. The data store 1110 may store user account data, user social authority scores and/or social authority data, advertisements, and/or advertising bids. The invention may also be practiced in a wide variety of network environments (represented by network 1112) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques of the present invention may be implemented in any suitable combination of software and/or hardware system, such as a web-based server or desktop computer system. Moreover, a system implementing various embodiments of the invention may be a portable device, such as a laptop or cell phone. The apparatus and/or web browser of this invention may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the disclosed method steps.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store instructions for performing the disclosed methods, displaying graphical user interfaces to be displayed in association with the disclosed methods, determining social authority scores, and/or facilitating advertiser bidding, etc.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

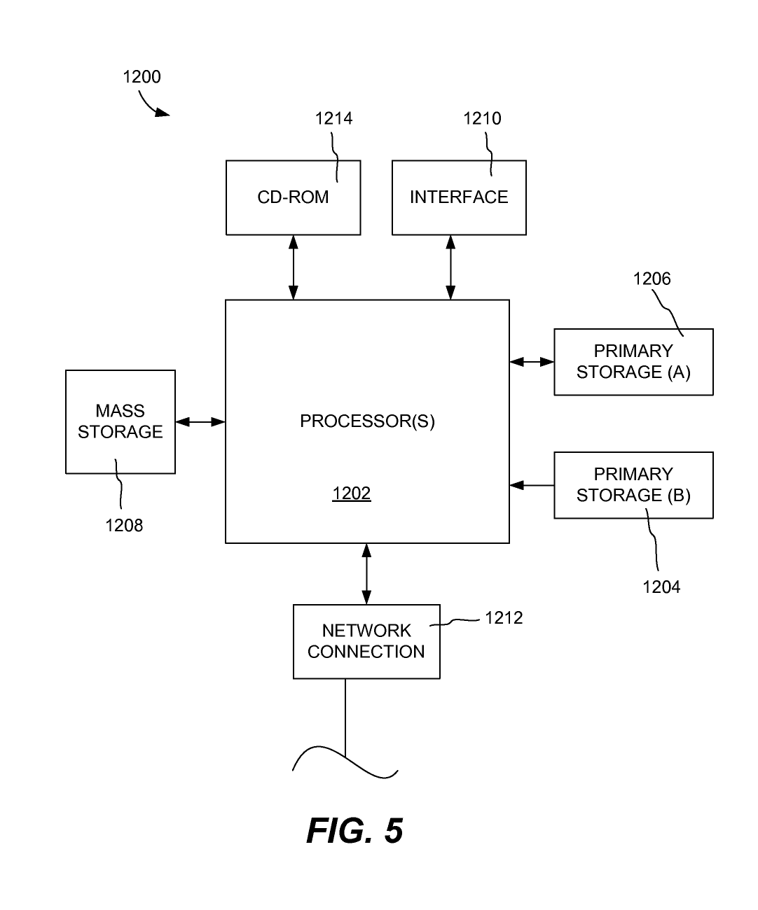

FIG. 5 illustrates a typical computer system that, when appropriately configured or designed, can serve as a system of this invention. The computer system 1200 includes any number of processors 1202 (also referred to as central processing units, or CPUs) that are coupled to storage devices including primary storage 1206 (typically a random access memory, or RAM), primary storage 1204 (typically a read only memory, or ROM). CPU 1202 may be of various types including microcontrollers and microprocessors such as programmable devices (e.g., CPLDs and FPGAs) and unprogrammable devices such as gate array ASICs or general purpose microprocessors. As is well known in the art, primary storage 1204 acts to transfer data and instructions uni-directionally to the CPU and primary storage 1206 is used typically to transfer data and instructions in a bi-directional manner. Both of these primary storage devices may include any suitable computer-readable media such as those described above. A mass storage device 1208 is also coupled bi-directionally to CPU 1202 and provides additional data storage capacity and may include any of the computer-readable media described above. Mass storage device 1208 may be used to store programs, data and the like and is typically a secondary storage medium such as a hard disk. It will be appreciated that the information retained within the mass storage device 1208, may, in appropriate cases, be incorporated in standard fashion as part of primary storage 1206 as virtual memory. A specific mass storage device such as a CD-ROM 1214 may also pass data uni-directionally to the CPU.

CPU 1202 may also be coupled to an interface 1210 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1202 optionally may be coupled to an external device such as a database or a computer or telecommunications network using an external connection as shown generally at 1212. With such a connection, it is contemplated that the CPU might receive information from the network, or might output information to the network in the course of performing the method steps described herein.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method, comprising:
determining a social authority score associated with a user, the social authority score indicating a level of social influence of the user;
identifying one of a plurality of advertisements based, at least in part, upon the social authority score associated with the user; and
providing the one of the plurality of advertisements to the user.

2. The method as recited in claim 1, further comprising:
ascertaining a charge for providing the identified one of the plurality of advertisements to the user based, at least in part, upon the social authority score associated with the user.

3. The method as recited in claim 1, further comprising:
ascertaining a charge for providing the identified one of the plurality of advertisements to the user based, at least in part, upon a range of social authority scores that has been specified in a bid submitted in association with the advertisement.

4. The method as recited in claim 1, further comprising:
obtaining a bid for the one of the plurality of advertisements from an advertiser, wherein the bid indicates a number of impressions that are to have a social authority score within a specified range of social authority scores.

5. The method as recited in claim 1, further comprising:
obtaining a bid for the one of the plurality of advertisements from an advertiser, wherein the bid indicates a first number of impressions that are to have a social authority score within a first range of social authority scores and a second number of impressions that are to have a social authority score within a second range of social authority scores.

6. The method as recited in claim 1, wherein identifying one of a plurality of advertisements to provide to the user based, at least in part, upon the social authority score associated with the user comprises:
identifying a plurality of advertisements, each of the plurality of advertisements being associated with a corresponding bid indicating a number of impressions that are to have a social authority score within a specified range of social authority scores; and
selecting the one of the plurality of advertisements, wherein the social authority score associated with the user is within the specified range of social authority scores for the one of the plurality of advertisements.

7. The method as recited in claim 1, wherein the social authority score pertains to a particular geographic region, topic, or type of business.

8. A computer-readable medium storing thereon computer-readable instructions, comprising:
instructions for determining a social authority score associated with a user, the social authority score indicating a level of social influence of the user;
instructions for identifying one of a plurality of advertisements based, at least in part, upon the social authority score associated with the user; and
instructions for providing the one of the plurality of advertisements to the user.

9. The computer-readable medium as recited in claim 8, further comprising:
instructions for ascertaining a charge for providing the identified one of the plurality of advertisements to the user based, at least in part, upon the social authority score associated with the user.

10. The computer-readable medium as recited in claim 8, further comprising:
instructions for ascertaining a charge for providing the identified one of the plurality of advertisements to the user based, at least in part, upon a range of social authority scores that has been specified in a bid submitted in association with the advertisement.

11. The computer-readable medium as recited in claim 8, further comprising:
instructions for obtaining a bid for the one of the plurality of advertisements from an advertiser, wherein the bid indicates a number of impressions that are to have a social authority score within a specified range of social authority scores.

12. The computer-readable medium as recited in claim 8, further comprising:
instructions for obtaining a bid for the one of the plurality of advertisements from an advertiser, wherein the bid indicates a first number of impressions that are to have a social authority score within a first range of social authority scores and a second number of impressions that are to have a social authority score within a second range of social authority scores.

13. The computer-readable medium as recited in claim 8, wherein identifying one of a plurality of advertisements to provide to the user based, at least in part, upon the social authority score associated with the user comprises:
identifying a plurality of advertisements, each of the plurality of advertisements being associated with a corresponding bid indicating a number of impressions that are to have a social authority score within a specified range of social authority; and
selecting one of the plurality of advertisements scores, wherein the social authority score associated with the user is within the specified range of social authority scores for the one of the plurality of advertisements.

14. The computer-readable medium as recited in claim 8, wherein the social authority score is based, at least in part, upon a number of users following the user or a number of contacts of the user.

15. An apparatus, comprising:
a processor; and
a memory, at least one of the processor or the memory being adapted for:
identifying one of a plurality of advertisements based, at least in part, upon a profile of a user;
providing the one of the plurality of advertisements to the user;
determining a social authority score associated with the user, the social authority score indicating a level of social influence of the user; and
ascertaining a charge for providing the identified one of the plurality of advertisements to the user based, at least in part, upon the social authority score associated with the user.

16. The apparatus as recited in claim 15, wherein identifying is further performed based, at least in part, upon the social authority score associated with the user.

17. The apparatus as recited in claim 15, at least one of the processor or the memory being adapted for performing further steps, comprising:
obtaining a bid for the one of the plurality of advertisements from an advertiser, wherein the bid indicates a number of impressions that are to have a social authority score within a specified range of social authority scores.

18. The apparatus as recited in claim 15, at least one of the processor or the memory being adapted for performing further steps, comprising:
obtaining a bid for the one of the plurality of advertisements from an advertiser, wherein the bid indicates a first number of impressions that are to have a social authority score within a first range of social authority scores and a second number of impressions that are to have a social authority score within a second range of social authority scores.

19. The apparatus as recited in claim 15, wherein identifying one of a plurality of advertisements to provide to the user based, at least in part, upon the social authority score associated with the user comprises:
identifying a plurality of advertisements, each of the plurality of advertisements being associated with a corresponding bid indicating a number of impressions that are to have a social authority score within a specified range of social authority scores; and
selecting one of the plurality of advertisements, wherein the social authority score associated with the user is within the specified range of social authority scores for the one of the plurality of advertisements.

20. The apparatus as recited in claim 15, wherein the social authority pertains to a particular geographic region, topic, or type of business.
